(19) United States
(12) Patent Application Publication
(10) Pub. No.: US 2026/0058520 A1
(43) Pub. Date: Feb. 26, 2026

(54) ASSEMBLY FOR ELECTRIC MACHINE

(71) Applicant: AMPERE S.A.S., Boulogne Billancourt (FR)

(72) Inventor: Eric DUMAS, Guyancourt Cedex (FR)

(73) Assignee: AMPERE S.A.S., Boulogne Billancourt (FR)

(21) Appl. No.: 18/851,871

(22) PCT Filed: Mar. 28, 2023
(86) PCT No.: PCT/EP2023/058038

§ 371 Date: Oct. 22, 2025

(30) Foreign Application Priority Data
Mar. 28, 2022 (FR) FR2202725

(51) Int. Cl. H02K 5/22; H02K 5/10

(52) U.S. Cl. CPC H02K 5/225; H02K 5/10

(57) ABSTRACT

An assembly for an electric machine includes a casing made of conductive material and connected to a reference potential, a rotor having an axis of rotation, and an electrically conductive connecting element that is in electric contact with the casing and with an electrically conductive part of the rotor. The connecting element extends along the axis of rotation

### TECHNICAL FIELD OF THE INVENTION

The present invention relates generally to the field of electric machines.

More specifically, it concerns an assembly for an electric machine.

The invention finds a particularly advantageous application in the production of electric machines for engines of automotive vehicles.

### STATE OF THE ART

An electric machine generally comprises a stator and a rotor arranged in a casing. During operation of the electric machine, the rotor becomes electrically charged in the same way as a capacitor. When the accumulated electric charge becomes too great, the rotor discharges, generating electric arcs along the paths of least resistance, i.e. in the ball bearings or the gears mechanically connected to the rotor output shaft. These electric arcs produce micro-deteriorations in the ball bearings or gears which, over the long term, increase rotor friction and degrade the performance of the electric motor.

One solution for controlling rotor discharge is to electrically connect the casing and the rotor output shaft by means of a conductive connecting element. The casing is connected to a reference potential. That way, the rotor can be “grounded.”

For example, an annular disc made of conductive felt is known from the document US2016/010750, which is arranged around the rotor output shaft and is in contact with the casing. However, felt is a fragile, expensive material, which limits its industrial application.

In addition, the tangential speed at the periphery of the rotor output shaft (which typically rotates at over 20,000 rpm) is high, resulting in significant wear on the connecting element.

Lastly, the connecting element requires the use of a longer and therefore more fragile output shaft.

### DESCRIPTION OF THE INVENTION

In this context, the present invention proposes an assembly for electric machine comprising:
a casing made of conductive material which is connected to a reference potential;
a rotor with an axis of rotation;
an electrically conductive connecting element which is in electric contact with the casing and with an electrically conductive part of the rotor, the connecting element extending along the axis of rotation.

Thus, thanks to the invention, the connecting element is arranged where the rotor's tangential speed is lowest. For example, for a rotor whose output shaft typically measures 30 mm in diameter, positioning the connecting element approximately three millimeters from the axis of rotation, instead of at the periphery of the output shaft, reduces the tangential speed in the area of contact with the connecting element by a factor of ten.

Consequently, the wear on the connecting element is greatly reduced.

In addition, there is no need to provide for a specific portion of output shaft length dedicated to contact with the connecting element. In other words, the assembly for electric machine according to the invention makes it possible to reduce the length of the output shaft compared with the rotor of the prior art, and thereby gain in compactness and solidity.

Other advantageous and non-limiting features of the device in accordance with the invention, taken individually or according to all the technically possible combinations, are as follows:
the connecting element is centered on the axis of rotation;
the connecting element is cylindrical, preferably revolving around the axis of rotation;
at least the rotor or the casing comprises a recessed relief into which the connecting element is partially inserted;
said recessed relief comprises a deep portion, a part of the connecting element being inserted in the deep portion, the deep portion being designed to fit together with said part, with some play;
said recessed relief comprises a flush portion opening towards the outside of at least said rotor or casing, the flush portion being flared toward the outside of at least said the rotor or the casing;
the connecting element comprises a rotationally symmetrical cylindrical body and, on the casing side, a head which is wider than the diameter of the body;
at least the rotor or the casing comprises a carbon arranged to be in contact with the connecting element;
said carbon delimits said recessed relief;
the connecting element is free to rotate around the axis of rotation relative to the rotor and the casing;
a contact surface between the connecting element and at least the rotor or the casing is less than 5 mm, and preferably less than 3 mm, away from the axis of rotation;
the assembly also comprises an annular deflector arranged around the connecting element so as to at least partially block the passage of dust or particles.

Of course, the various features, variants and embodiments of the invention can be associated with one another in various combinations as long as they are not incompatible or mutually exclusive.

### DETAILED DESCRIPTION OF THE INVENTION

The following description of the invention with reference to the attached drawings, which are given as non-limiting examples, will make it possible to understand clearly what the invention consists of and how it can be made.

On the attached drawings:

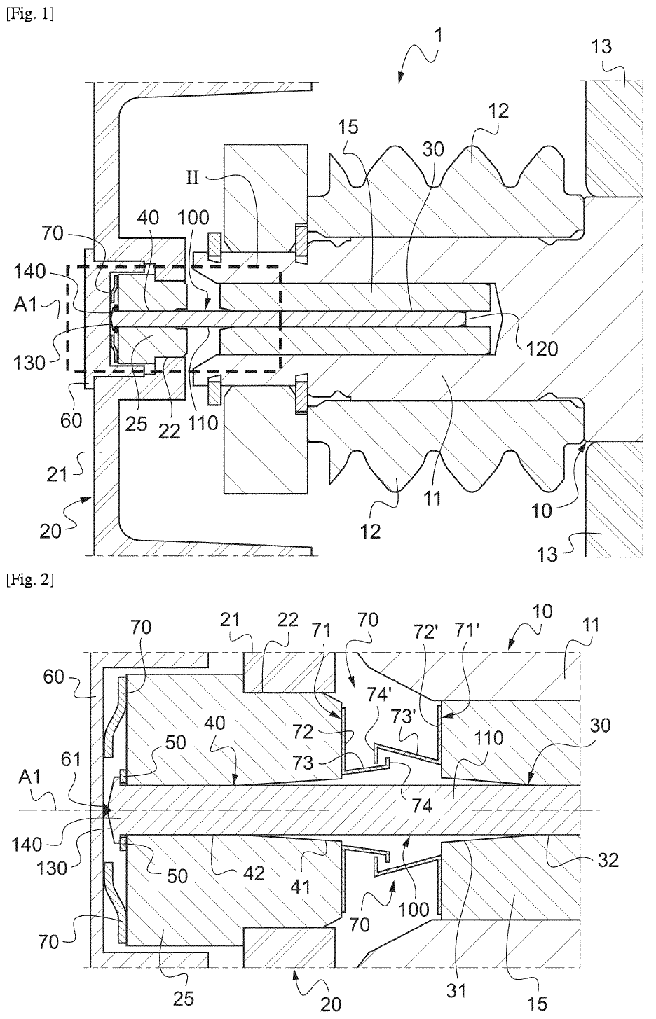

FIG. 1 is a schematic cross-sectional view of a first embodiment of an assembly for electric machine according to the invention;

FIG. 2 is a detail view of zone II of [FIG. 1], the assembly being equipped with a deflector;

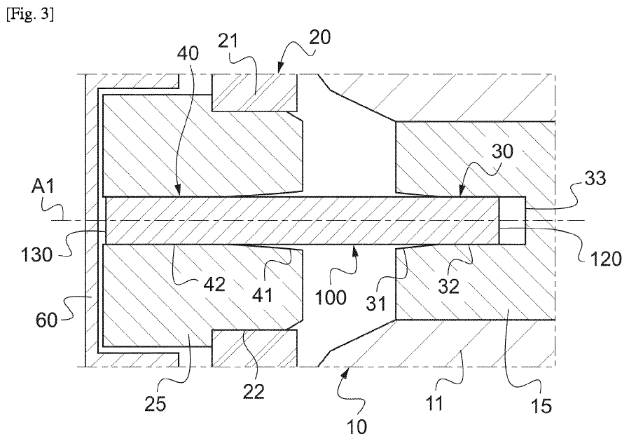

FIG. 3 is a schematic cross-sectional view of a second embodiment of an assembly for electric machine according to the invention.

An assembly 1 for an electric machine according to the invention is shown in [FIG. 1]. The assembly 1 comprises a rotor 10 and a casing 20.

The assembly 1 is here intended to form part of an electric machine such as an electric motor for an automotive vehicle. The electric machine further comprises a stator (not shown).

Typically, the rotor 10 has the shape of a disk or cylinder centered around an axis of rotation A1. The rotor 10 comprises magnetic elements 13, such as electromagnets or permanent magnets. The stator has the shape of a flattened ring and is equipped, on its side facing the rotor 10, with teeth around which are wound coils of electrically conductive wires. When those coils are supplied with electric current, they generate a rotating magnetic field which drives the magnetic elements 13, setting the rotor 10 in motion around the axis of rotation A1.

To transmit this rotary motion to the outside of the electric machine, the rotor 10 comprises an output shaft 11, which also rotates around the axis of rotation A1. Here, it also includes gear teeth 12, as shown in [FIG. 1]. The rotor 10, and in particular the output shaft 11, is made of electrically conductive material. The output shaft 11 is made of aluminum or steel, for example.

The rotor 10 and the stator are mounted in the casing 20, which holds them in place and protects them from external influences (impacts, dust, etc.). The stator is fixed relative to the casing 20, while the rotor 10 is held so that it can rotate freely around its axis of rotation A1 relative to the casing 20, for example by means of ball bearings.

The casing 20, or at least a part of it, is made of electrically conductive material. Said part of casing 20 thereby comprises a metallic material such as aluminum. Said part of casing 20 is electrically connected to a reference potential, which forms the vehicle's ground.

As shown in [FIG. 1], the assembly 1 also includes an electrically conductive connecting element 100. The connecting element 100 is in electric contact both with the casing 20 and with the rotor 10, here with the output shaft 11 of the rotor 10. The connecting element 100 thereby “grounds” the rotor 10 by connecting it to the reference potential of the casing 20.

Preferably, the connecting element 100 is made of a material with low electric resistivity. Here, the connecting element 100 is made of a metallic material, particularly copper. The electric charges accumulated by the rotor 10 as it rotates are thereby efficiently conducted to the casing 20. In addition, the connecting element 100 according to the invention is inexpensive and durable. The connecting element 100 can also be made of aluminum.

As shown in [FIG. 1], the connecting element 100 extends along the axis of rotation A1. This means here that the connecting element 100 has a main dimension substantially parallel to the axis of rotation A1 and that the connecting element 100 is traversed by the axis of rotation A1. By contrast, this also means that the connecting element 100 has transverse dimensions that are smaller than the main dimension and that are substantially orthogonal to the axis of rotation A1.

Here, the connecting element 100 extending along the axis of rotation A1 notably manifests in the fact that the latter is globally elongated with two opposite ends 120, 130 that are aligned on the axis of rotation A1, as shown in FIGS. 1 and 3. A first end 120 is in contact with the rotor 10, while a second end 130 is in contact with the casing 20.

As shown in [FIG. 1], the connecting element 100 is more specifically centered on the axis of rotation A1. In general, this means that the connecting element 100 has a geometric center of inertia positioned on the axis of rotation A1. Here, the connecting element 100 more precisely has a medium fiber (or neutral fiber) that is substantially coincident with the axis of rotation A1.

The connecting element 100, as shown in FIGS. 1 to 3, is cylindrical here and its generatrices are substantially parallel to the axis of rotation A1. More specifically, the connecting element 100 extends along a cylindrical surface of revolution. Thus, the connecting element 100 has an axis of symmetry which here, because the connecting element 100 is centered on the axis of rotation A1, is coincident with the axis of rotation A1.

By way of example, the rotationally cylindrical connecting element 100 has a diameter of between 1 mm and 4 mm and a height, i.e. a length along the axis of rotation A1, of between 15 mm and 30 mm. The length and diameter of the connecting element 100 can be adapted to give it a desired bending strength or stiffness. The stiffness of the connecting element 100 can also be adapted by heat treatment.

The arrangement of the connecting element 100 in relation to the rotor 10 and the casing 20 is illustrated in detail in FIGS. 1 to 3.

As shown in [FIG. 1], the connecting element 100 is partly inserted into the rotor 10 (on the side of the first end 120), and into the casing 20 (on the side of the second end 130). The cylindrical surface of revolution of the connecting element 100 thereby offers a contact surface large enough to ensure electric conduction. Remarkably, since the connecting element 100 is inserted into the rotor 10 along the axis of rotation A1, the tangential speed in the contact zone between the connecting element 100 and the rotor 10 remains relatively low, for example in comparison with the tangential speed at the periphery of the output shaft 11. Thus, the connecting element 100 is subjected to little wear due to the rotation of the rotor 10.

Here, the contact surface between the connecting element 100 and the rotor 10 is less than 5 mm, and preferably less than 3 mm, away from the axis of rotation A1. Likewise, the contact surface between the connecting element 100 and the casing 20 is less than 5 mm, and preferably less than 3 mm, away from the axis of rotation A1.

To position the connecting element 100 in the rotor 10 and the casing 20, the rotor 10 comprises a first recessed relief 30 and the casing 20 comprises a second recessed relief 40. Each recessed relief 30, 40 has a shape adapted to receive the connecting element 100. Each recessed relief 30, 40 is also centered on the axis of rotation A1. The first recessed relief 30 is located inside the output shaft 11 of the rotor 10. The length of insertion of the connecting element 100 into the recessed reliefs 30, 40 is, for example, between 5 mm and 12 mm.

As shown in [FIG. 2], the first recessed relief 30 provided inside the output shaft 11 of the rotor 10 comprises a flush portion 31 and a deep portion 32, which are aligned along the axis of rotation A1 and are contiguous. The flush portion 31 opens onto the outside of rotor 10 toward the casing 20. Therefore, the flush portion 31 of the first recessed relief 30 faces the casing 20. The deep portion 32 is located opposite the casing 20 with respect to the flush portion 31, at the bottom of the first recessed relief 30. From the casing 20, the first recessed relief 30 here consists of the flush portion 31 and then the deep portion 32.

In the same way, as shown in [FIG. 2], the second recessed relief 40 provided inside the casing 20 also comprises a flush portion 41 and a deep portion 42, which are aligned along the axis of rotation A1 and are contiguous. The flush portion 41 opens onto the outside of the casing 20 toward the rotor 10 and therefore faces the rotor 10. The deep portion 42 is located opposite the rotor 10 with respect to the flush portion 41, at the bottom of the second recessed relief 40. From the rotor 10, the second relief 40 here consists of the flush portion 41 and then the deep portion 42.

Each flush portion 31, 41 and each deep portion 32, 42 is designed to accommodate a part of the connecting element 100. The said part being, for example, between 20% and 50% of the length of the connecting element 100. Here, however, the deep portions 32, 42 are specifically adapted to the shape of the connecting element 100, with some play, while the flush portions 31, 41 are flared to tolerate bending of the connecting element 100.

Here, each deep portion 32, 42 has, more particularly, a rotationally cylindrical inner surface whose diameter is equal to that of the connecting element 100, with some play. The deep portions 32, 42 and the connecting element thereby have an interlocking fit with some play, i.e. in which the fit is positive so that the connecting element 100 can pivot freely in the recessed reliefs around the axis of rotation A1.

In practice, dispersions on the straightness of the connecting element 100 due to its manufacture generate several contact zones between it and the deep portions 32, 42, which allows electricity to pass efficiently while ensuring low frictional resistance.

Here, each flush portion 31, 41 has an increasing diameter, along the axis of rotation A1, from the deep portions 32, 42 toward the outside of the rotor 10 or the casing 20. Their diameter may, for example, increase from a diameter equal to that of the connecting element 100 (and therefore of the deep portions 32, 42) to a diameter 5% to 10% greater than that of the connecting element 100.

By way of example, the flush portions 31, 41 can have an inner surface extending along a frustoconical surface which forms an angle with the axis of rotation A1 of between 5 degrees and 15 degrees. As another example, the diameter of the flush portions 31, 41 may increase parabolically as shown in FIGS. 2 and 3.

The flush portions 31, 41 are thus slightly wider than the connecting element 100 in order to allow mechanical tolerance, i.e. slight bending, when the axis of rotation A1 of the rotor 10 moves slightly and briefly relative to the casing 20, for example when the automotive vehicle experiences a jolt.

The recessed reliefs 30, 40 can be pass-through, such as the second recessed relief 40 shown in [FIG. 1], or obstructed, such as the first recessed relief 30 shown in [FIG. 3].

It could be provided that the recessed reliefs be made directly in the casing and in the rotor output shaft.

But here, on the contrary, they are made in intermediate pieces called “carbons.” Thus, advantageously, the rotor 10 comprises a first carbon 15. Here, the first carbon 15 is engaged into a suitable hollow in the rotor shaft 11 of the rotor 10. More specifically, the casing 20 comprises a metallic casing block 21, which is connected to the reference potential (the casing block 21 here corresponds to the electrically conductive sub-part of the casing 20), and a second carbon 25. The casing block 21 forms a hollow reinforcement that delimits a well 22, the bottom of which defines an opening into which the second carbon 25 is engaged. The carbons 15, 25 are girded into the output shaft 11 and into the casing block 21, and are thus fixed into them.

The carbons 15, 25 are parts characterized by their high electric conductivity and mechanical strength, as well as their low adhesion or even self-lubricating capacity. Here, the carbons 15, 25 are made of graphite.

The first recessed relief 30 is provided in the first carbon 15, while the second recessed relief 40 is then provided in the second carbon 25. In other words, the carbons 15, 25 delimit the recessed reliefs 30, 40.

Thus, the connecting element 100 is in contact with the carbons 15, 25, which in turn are in contact with the output shaft 11 of the rotor 10 and the casing block 21 of the casing 20. The contact between the connecting element 100 and the carbons 15, 25 is both a mechanical and electrical direct contact. This ensures greater resistance to wear than in the case where the connecting element 100 is in direct contact with the metal constituting the rotor 10 or the casing block 21, thanks in particular to the non-stick properties of the carbons 15, 25. Since the carbons 15, 25 are very good electric conductors, they have very little effect on the passage of electricity. Preferably, the connecting element 100 is exclusively in contact with the carbons 15, 25.

For example, the carbons 15, 25 can have cylindrical external shapes, for example with a diameter between 10 mm and 15 mm, or parallelepipedic shapes.

The connecting element 100 is preferably free to rotate both relative to the casing 20 and relative to the rotor 10. That enables it to turn freely, at a speed lower than the rotational speed of the rotor 10, and consequently to limit overall wear of the contacts with the casing 20 and the rotor 10. In practice, the rotational speed of the connecting element 100 stabilizes at around half the rotational speed of the rotor 10, so the wear on the connecting element 100 is distributed more or less equally between the two carbons 15, 25.

In a first embodiment, shown in FIGS. 1 and 2, the connecting element 100 is transposably fixed along the axis of rotation A1. The advantage of this embodiment is to improve the electric contact between the rotor 10 and the casing 20.

As shown in [FIG. 1], in this first embodiment, the connecting element 100 more specifically comprises a body 110 and a head 140 on the side of the second end 130 of the connecting element 100 (the one facing the casing 20). The body 110, which is rotationally cylindrical, represents here more than 90%, and in particular more than 95%, of the length of the connecting element 100 along the axis of rotation A1. The head 140 is wider than the body 110. This means here that one of its dimensions transverse to the axis of rotation A1 is greater than the diameter of the body 110. Here it forms a kind of nail head. The connecting element 100 thus has the overall shape of a nail. Plus, in this first embodiment, the second recessed relief 40 is pass-through.

As shown in [FIG. 2], the head 140 is supported on one side of the second carbon 25 opposite the rotor 10, which holds the connecting element 100 on one side along the axis of rotation A1.

As shown in [FIG. 1], the assembly 1 also comprises a plug 60 embedded or screwed into the casing block 21. The head 140 is then sandwiched between the plug 60 and the second carbon 25, which locks the connecting element 100 along the axis of rotation A1. Here, a metal washer 50 is interposed between the head 140 and the second carbon 25 to facilitate tightening the head 140 onto the second carbon 25.

Preferably, the contact between the plug 60 and the connecting element 100 is made by means of a pin 61 arranged on the plug 60. As shown in [FIG. 2], the pin 61 has, for example, the shape of a conical pyramid along the axis of rotation A1, which leaves the connecting element 100 free to rotate. The pin 61 can be made of a harder material than the connecting element 100, so as to deform the head 140. Conversely, the pin 61 can be softer, so as to undergo deformation.

The assembly 1 may also include at least one spring 70, provided between the plug 60 and the second carbon 25, to improve the holding of the second carbon 25 relative to the casing 20.

In a second embodiment, shown in [FIG. 3], the connecting element 100 is left transposably mobile along the axis of rotation A1.

For that, unlike in the first embodiment, the connecting element 100 does not comprise any enlarged end. Thus, in this second embodiment, the connecting element 100 is essentially cylindrical.

As suggested in [FIG. 3], the connecting element 100 can move transposably along the axis of rotation A1 between the plug 60 and a bottom 33 of the first recessed relief 30, which thereby form stops for the connecting element 100.

In this second embodiment, the connecting element 100 is less mechanically constrained, in the sense that it has more degrees of freedom than in the first embodiment, and is thus better able to withstand a momentary shift of the axis of rotation A1 relative to the casing 20.

Regardless of the embodiment, the assembly 1 can also include a deflector 70 arranged around the periphery of the connecting element 100, as shown in [FIG. 2]. The deflector 70 blocks any dust or particles that would be produced by the friction of the connecting element 100 in the recessed reliefs 30, 40. Thanks to the deflector 70, such dust or particles will not pollute the oil mist contained in the casing 20 and used for lubrication.

As shown in [FIG. 2], the deflector 70 here comprises two rings 71, 71′ each having a base 72, 72′ which is respectively in contact with one of the carbons 15, 25 and a lip 73, 73′ raised along the axis of rotation A1. The rings 71, 71′ are made of semi-rigid materials, for example silicone or polyamide. The bases 72, 72′, for example, are bonded to the carbons 15, 25.

The lip 73, 73′ of each ring 71, 71′ rises above the lip 73, 73′ of the other ring 71, 71′ (in other words, they are interlocked). Thus, the connecting element 100 is completely surrounded by the deflector 70, from the casing 20 to the rotor 10. Each ring 71, 71′ ends in a fold 74, 74′ towards the lip 73, 73′ of the other ring 71, 71′. Dust or particles are thereby blocked at the junction between the lips 73, 73′ and the folds 74, 74′.

The present invention is by no means limited to the embodiments described and shown, but one skilled in the art will know how to make any variant therein in accordance with the invention.

By way of example, the connecting element may be cylindrical while having a non-circular transverse cross-section. The connecting element may also have an axis of symmetry along the axis of rotation without being cylindrical. Similarly, the recessed reliefs may be not rotationally cylindrical. The connecting element may also be fixed in relation to the casing or the rotor, and therefore be movable only in one of the two recessed reliefs. The recesses can be made directly in the metal forming the casing and the rotor. Therefore, it is not necessary to use carbons. The first recessed relief can be made elsewhere than in the rotor output shaft, for example opposite it. Lastly, the connecting element can be in contact with the rotor or the casing without being inserted into them, for example by means of a flat contact at one of its bases. The connecting element can then be held against the rotor or casing by a metal spring.

1-10. (canceled)

11. An assembly for electric machine, comprising:
a casing made of conductive material, which is connected to a reference potential;
a rotor with an axis of rotation;
an electrically conductive connecting element, which is in electric contact with the casing and with an electrically conductive part of the rotor;
wherein the connecting element extends along the axis of rotation.

12. The assembly according to claim 11, wherein the connecting element is centered on the axis of rotation.

13. The assembly according to claim 11, wherein the connecting element is cylindrical in shape.

14. The assembly according to claim 13, wherein the connecting element is rotationally symmetrical around the axis of rotation.

15. The assembly according to claim 11, wherein at least either the rotor or the casing comprises a recessed relief into which the connecting element is partly inserted.

16. The assembly according to claim 15, wherein said recessed relief comprises a deep portion, a part of the connecting element being inserted into the deep portion, the deep portion being configured to fit together with said part of the connecting element, with some play.

17. The assembly according to claim 16, wherein said recessed relief comprises a flush portion opening toward an outside of said at least rotor or casing, the flush portion being flared toward the outside of said at least rotor or casing.

18. The assembly according to claim 11, wherein the connecting element comprises a rotationally cylindrical body and, on a side of the casing, a head wider than a diameter of the body.

19. The assembly according to claim 11, wherein at least either the rotor or the casing comprises a carbon arranged to be in contact with the connecting element.

20. The assembly according to claim 11, wherein the connecting element is free to rotate around the axis of rotation relative to the rotor and the casing.

21. The assembly according to claim 11, further comprising an annular deflector arranged around the connecting element so as to at least partially block a passage of dust or particles.
